(19) United States
(12) Patent Application Publication
(10) Pub. No.: US 2012/0034288 A1
(43) Pub. Date: Feb. 9, 2012

(54) COMPOSITIONS AND METHODS FOR ENHANCED ATTRACTION OF NOCTUID MOTHS

(76) Inventor: GERALD H. MCKIBBEN, STARKVILLE, MS (US)

(21) Appl. No.: 12/850,546

(22) Filed: Aug. 4, 2010

(51) Int. Cl. A01N 25/08; A01P 19/00; A01N 35/02

(52) U.S. Cl. 424/409; 514/703

(57) ABSTRACT

The invention provides compositions for attracting noctuid moths, which include at least one pheromone and at least one enhancer. The enhancer is a naturally-occurring phytochemical compound. The enhancer is preferably trans-2, cis-6-nonadienal. The invention also provides lures and traps containing the composition for attracting noctuid moths, and methods for attracting, capturing, killing or sterilizing noctuid moths using the composition.

### FIELD OF THE INVENTION

The invention is directed to novel compositions and methods using these novel compositions for attracting moths, particularly noctuid moths.

### BACKGROUND OF THE INVENTION

Noctuid moths including cotton bollworm, beet armyworm, corn earworm, and tobacco bud worm are pests that attack several economically important crops, including cotton. Although a variety of chemical pesticides have been used in the past to control noctuid moths, there are serious disadvantages with these pesticides. Some pesticides pollute the environment while others are toxic to humans. Such environmental and consumer safety concerns have led to the deregistration of many pesticides. Also, there is generally a reluctance to use any pesticides on agricultural products that are consumed as food. Therefore, eliminating, or at least reducing, the amount of toxic pesticides used in the management of insect pests is desirable. Consequently, scientists have pursued the development of alternative pest control agents that are safer for the environment and for consumers. Among such alternative control agents are insect sex pheromones.

Many insects communicate by releasing volatile pheromones. Sex pheromones, for example, are typically released by one sex at appropriate times to attract the other sex of the same species. This phenomenon has been exploited to trap the insects of one sex and kill them, thereby preventing mating and reducing the insect population in following generations. Pheromones have been used in this way on a commercial basis for several years, and provide effective control of numerous insect pest species including noctuid moths.

Although the use of pheromones is advantageous, most pheromones are artificially synthesized, and thus are very expensive. As a result, pest control or pest management using synthetic pheromones is not always cost efficient. In some cases, naturally occurring and less-expensive compounds can be identified that act as enhancers to synthetic pheromones. For example, eugenol, a naturally occurring compound, has been identified as an enhancer and is used with the synthetic pheromone, grandlure, for capturing and controlling cotton boll weevils. The naturally-occurring compound adds to the attractant effect of the grandlure (McKibben et al., U.S. Pat. No. 6,183,733). In addition, U.S. application Ser. No. 11/774,309, incorporated herein by reference, describes several noctuid pheromones such as (Z,E)-9,12-tetradecadien-1-ol acetate and (Z)-9-tetradecen-1-ol acetate as well as mixtures thereof. An additional pheromone disclosed therein is (Z)-11-hexadecen-1-ol. In addition this application describes enhancers, such as β-caryophyllene, iso-caryophyllene and α-humulene.

### SUMMARY OF THE INVENTION

In one aspect the invention provides a composition comprising at least one pheromone compound that attracts at least one species of Heliothis and an enhancer. In one aspect the enhancer is trans-2, cis-6-nonadienal. In one aspect the species of Heliothis is Heliothis zea.

In one aspect the invention provides a trap for capturing an insect comprising at least one pheromone compound that attracts at least one species of Heliothis and an enhancer. In one aspect the enhancer is trans-2, cis-6-nonadienal. In one aspect the species of Heliothis is Heliothis zea.

In one aspect the invention provides a method of preparing a trap for attracting noctuid moths comprising administering to a substrate an effective amount of a first and second agent for attracting at least one species of a noctuid moth, wherein the first agent is a pheromone compound that attracts at least one species of Heliothis and the second agent is trans-2, cis-6-nonadienal. In one aspect the species of Heliothis is Heliothis zea.

In one aspect the invention provides a method for attracting noctuid moths comprising placing in a field a trap comprising an effective amount of a first and second agent for attracting at least one species of a noctuid moth, wherein the first agent is a pheromone compound that attracts at least one species of Heliothis and the second agent is trans-2, cis-6-nonadienal, whereby the noctuid moths are attracted to the trap. In one aspect the species of Heliothis is Heliothis zea.

### BRIEF DESCRIPTION OF THE DRAWINGS

FIG. 1 illustrates a response of Heliothis virescens in a cotton environment to pheromone compositions with and without β-caryophyllene as a synergist.

FIG. 2 illustrates a response of Heliothis virescens in a cotton environment to pheromone compositions with and without β-caryophyllene as a synergist.

FIG. 3 illustrates a response of Spodoptera exigua in a cotton environment to pheromone compositions with and without β-caryophyllene as a synergist.

FIG. 4 illustrates a response of Spodoptera exigua in a cotton environment to pheromone compositions with and without β-caryophyllene as a synergist.

### DETAILED DESCRIPTION OF THE INVENTION

The invention provides attractant-compositions comprising at least two compounds. In one embodiment the first compound is a pheromone and the second compound is an enhancer, as defined herein. The term “pheromone” as used herein, means a volatile chemical or a set of volatile chemicals that attract at least one species of noctuid moth.

In one embodiment the noctuid moth is an economically important species of Lepidoptera, particularly in the family Noctuidae, and more particularly in the subfamilies Plusiinae, Heliothinae, and Cuculliinae, and in the families Pyralidae and Sphingidae. In some embodiments, the attractant-composition attracts insects of one or more species of the genus Spodoptera. In one embodiment, the attractant-composition attracts Spodoptera exigua. In another embodiment, the attractant-composition attracts insects of one or more species of the genus Heliothis. In another particular embodiment, the attractant-composition attracts Heliothis virescens. In one embodiment the attractant composition attracts Heliothis zea. The attractants are useful for attracting male, female or male and female moths to lures containing the attractants and provide a mechanism for detecting, surveying, monitoring, and controlling these pests. In particular embodiments of the invention, it was surprisingly found that trans-2,cis-6-nonadienal functioned as an enhancer for attracting H. zea, whereas other compounds such as caryophyllene did not.

Lepidopteran pheromones suitable for use herein are generally well-known in the art. Overviews of the pheromones for many insects, including many Lepidoptera, have been described, and include, for example, Mayer and McLaughlin (Handbook of Insect Pheromones and Sex Attractants, CRC Press, Boca Raton, Fla., 1991) and Tamaki (Sex Pheromones, In Comprehensive Insect Physiology Biochemistry and Pharmacology, Vol. 9 Behavior, Kerkut and Gilbert (Ed.), Pergamon Press, New York, pp. 145-179). In some embodiments, the pheromone is a sex pheromone that attracts one sex of a noctuid moth. In particular embodiments, the pheromone is selected from the group (Z,E)-9,12-tetradecadien-1-ol acetate, (Z)-9-tetradecen-1-ol acetate and (Z)-11-hexadecen-1-ol, and combinations thereof. In one embodiment, the pheromone for attracting beet army worm is a mixture of (Z,E)-9,12-tetradecadien-1-ol acetate and (Z)-9-tetradecen-1-ol acetate, preferably, in a ratio of 7:3. In another embodiment, the pheromone for attracting tobacco bud worm is (Z)-11-hexadecen-1-ol or its isomer. In one embodiment the pheromone attracts Heliothis zea. The pheromone may be naturally occurring or chemically synthesized by methods known to one skilled in the art. In some aspects the attractive sex pheromone of the H. zea is Z-11-hexadecenal (Z-11-16:A1d), Z-9-hexadecenal (Z-9-16:A1d), Z-7-hexadecenal (Z-7-16:A1d) or hexadecenal (16:A1d). Combinations of these pheromones also find use as attractants for H. zea. In one aspect, the pheromone composition is a blend of the major component Z-11-hexadecenal (Z-11-16:A1d), with lesser amounts of Z-9-hexadecenal (Z-9-16:A1d), Z-7-hexadecenal (Z-7-16:A1d) and/or hexadecenal (16:A1d). In some embodiments pheromone lures include blends of some or all of these compounds. Combinations of any 2, 3 or 4 of these pheromones find use as Heliothis zea pheromones, e.g. attractants. In some embodiments the pheromone is commercially available, for example as found in commercially available traps or lures, such as a commercial Heliothis zea pheromone dispenser produced by Hercon.

The term “enhancer” as used herein, refers to a substance that can be used with a noctuid-moth-pheromone for reducing the amount of the pheromone dose or enhancing the effectiveness of the pheromone for attracting at least one species of noctuid moth. The enhancer may or may not be an independent attractant of noctuid moths in the absence of a pheromone.

In one embodiment, the enhancer is a volatile phytochemical that attracts at least one species of noctuid moth. The term, “phytochemical,” as used herein, means a compound occurring naturally in a plant species.

In one embodiment, the enhancer is selected from the group comprising β-caryophyllene, iso-caryophyllene and α-humulene, and combinations thereof. In one embodiment, the enhancer is β-caryophyllene or its Z isomer. In one embodiment the enhancer is trans-2, cis-6-nonadienal, a compound reported from the volatiles of corn and soybean plants.

The attractant-composition may contain the pheromone and the enhancer in a mixed or otherwise combined form or it may contain the pheromone and the enhancer independently in a non-mixed form. In some embodiments the range of ratios of pheromone to enhancer: 100:0.1, 100:1, 90:10, 75:25, 50:50, 25:75, 10:90, 1:100 or 0.1:100.

The attractant-compositions may include one or more insecticides. In one embodiment, the insecticides are chemical insecticides known to one skilled in the art. Examples of the chemical insecticides include one or more of pyrethoroid or organophosphorus insecticides, including but are not limited to, cyfluthrin, permethrin, cypermethrin, bifinthrin, fenvalerate, flucythrinate, azinphosmethyl, methyl parathion, and malathion.

In another embodiment, the insecticides are one or more biological insecticides known to one skilled in the art. Examples of the biological insecticides include, but are not limited to, toxins from natural pyrethrins, Bacillus thuringiencis and Beauveria bassiana.

In certain embodiments, the attractant-composition may include one or more polymeric agents known to one skilled in the art. The polymeric agents may control the rate of release of the composition to the environment. In some embodiments, the polymeric attractant-composition is impervious to environmental conditions. The polymeric agent may also be a sustained-release agent that enables the composition to be released to the environment in a sustained manner.

Examples of polymeric agents include, but are not limited to, celluloses, proteins such as casein, fluorocarbon-based polymers, hydrogenated rosins, lignins, melamine, polyurethanes, vinyl polymers such as polyvinyl acetate (PVAC), polycarbonates, polyvinylidene dinitrile, polyamides, polyvinyl alcohol (PVA), polyamide-aldehyde, polyvinyl aldehyde, polyesters, polyvinyl chloride (PVC), polyethylenes, polystyrenes, polyvinylidene, silicones, and combinations thereof. Examples of celluloses include, but are not limited to, methylcellulose, ethyl cellulose, cellulose acetate, cellulose acetate-butyrate, cellulose acetate-propionate, cellulose propionate, and combinations thereof.

According to another embodiment of the invention, the attractant-composition may include one or more insect feeding stimulants. Examples of insect feeding stimulants include, but are not limited to, crude cottonseed oil, fatty acid esters of phytol, fatty acid esters of geranyl geraniol, fatty acid esters of other plant alcohols, plant extracts, and combinations thereof.

According to another embodiment of the invention, the attractant-composition may include one or more insect growth regulators (“IGRs”). IGRs may be used to alter the growth of the noctuid moths and produce deformed noctuid moths. Examples of insect growth regulators include, for example, DIMILIN™ (diflubenzuron), INTREPID™ (methoxyfenozide), CONFIRM™ (tebufenozide), ESTEEM™ (pyriproxyfen), and DIAMOND™ (Novaluron/difluorobenzamide).

According to another embodiment of the invention, the attractant-composition may include one or more insect sterilants that sterilize the trapped insects or otherwise block their reproductive capacity, thereby reducing the population in the following generation. In some situations allowing, the sterilized insects to survive and compete with non-trapped insects for mates is more effective than killing them outright.

According to another embodiment of the invention, the attractant-composition may include one or more additives that enhance the stability of the composition. Examples of additives include, but are not limited to, fatty acids and vegetable oils, such as for example olive oil, soybean oil, corn oil, safflower oil, canola oil, and combinations thereof.

Furthermore, according to another embodiment of the invention, the attractant-composition may include one or more fillers. Examples of fillers include, but are not limited to, one or more mineral clays (e.g., attapulgite). In some embodiments, the attractant-composition may include one or more organic thickeners. Examples of such thickeners include, but are not limited to, methyl cellulose, ethyl cellulose, and any combinations thereof.

The attractant-compositions of the present invention may also include one or more solvents. Compositions containing solvents are desirable when a user is to employ liquid compositions which may be applied by brushing, dipping, rolling, spraying, or otherwise applying the liquid compositions to substrates on which the user wishes to provide an insecticidal coating. In some embodiments, the solvent(s) to be used in the instant invention is/are selected so as to solubilize, or substantially solubilize, the one or more ingredients of the attractant-composition. Examples of solvents include, but are not limited to, ethyl alcohol, methyl alcohol, chlorinated hydrocarbons, petroleum solvents, turpentine, xylene, and any combinations thereof.

The attractant-composition may also include one or more binders, such as synthetic and natural resins typically used in paints and coatings. These may be modified to cause the coated surface to be friable enough to allow insects to bit off and ingest the material, while still maintaining the structural integrity of the coating. In some embodiments, the binder also acts a filler and/or a thickener. Examples of binders include, but are not limited to, one or more of shellac, acrylics, epoxies, alkyds, polyurethanes, linseed oil, tung oil, and any combinations thereof.

The compositions of the invention are useful in detecting, surveying, monitoring, or controlling noctuid moth populations when used as a lure. A lure may include a dispenser that contains the enhancer and/or the pheromone as well as other agents outlined herein. For purposes of this invention, a dispenser contains or holds the unvolatilized compound or compounds used to produce the vapor of the enhancer and/or pheromone and releases the compound or compounds in the vapor phase.

A dispenser may take several forms. In one embodiment, a formulation to produce the volatilized compounds or mixture is contained for release into a selected area where moths may occur. Dispensers may include a substrate such as an adsorbent material such as cotton or paper which both holds and releases a compound or mixture. In general, however, a dispenser will comprise a reservoir in or on a substrate for holding an amount of a compound either within a space or a polymeric matrix, with the release into the atmosphere controlled by a permeable wall or membrane or by a small opening surrounded by an impermeable wall or membrane. Examples of dispensers include a reservoir and polyethylene cap within a trap. Additional examples of dispensers include polymer caps, bubbles, hollow fibers, hollow tubes or tubing which release compounds through the walls, capillary tubing which release compounds out of an opening in the tubing, polymeric blocks of different shapes which release compounds out of the polymer matrix, membrane systems which hold the chemicals within an impermeable container and release them through a measured permeable membrane, and combinations of the foregoing. Examples of other dispensers are polymer laminates, polyvinyl chloride pellets, microcapillaries, and Shunitzu rope. Another dispenser includes using microencapsulation techniques to encapsulate each compound used to produce the vaporized compound, mixture or vapor blend.

In one aspect of the invention, the individual compounds may be formulated as a mixture in a dispenser to produce the volatilized blend of the attractant combination. In another aspect, individual compounds are provided in separate dispensers, e.g., a first and second dispenser, which are positioned in sufficient proximity to one another to provide an effective moth attractant volatilized blend in the surrounding atmosphere. The first and second dispensers may optionally be attached or fused to form one device or unit that releases the compounds to form the vapor blend. Alternatively, the individual compounds may be formulated in separate dispensers, for example, placing in individual vials.

The attractant compositions may also be combined with feeding stimulants to provide baits for moths, particularly pestiferous noctuid species. Toxicants may also be added to provide poisoned baits, as discussed in detail herein. Insect growth regulators or insecticides also may be included in the lure. These agents may be combined in a composition with the pheromone and enhancer as described herein. Alternatively, the agents may be placed individually in/on the lure.

The pheromone and enhancers of the invention may be used as detecting agents, surveying agents, monitoring agents, or control agents for the moths. The agents may be placed within a trap which allows the insects to enter but prevents their exit. In this manner, the foraging power of the colony is reduced thereby achieving some degree of control over the colony. A trapping system for monitoring or controlling moths includes a trap and a dispenser located within the trap, which provides an effective amount of the pheromone and enhancer of the invention. In a first embodiment the composition provides a vapor blend comprising vapor of the pheromone and enhancer as described herein. In one embodiment the enhancer is trans-2, cis-6-nonadienal.

A trap is any device for catching insects, particularly, noctuid moths. These include for example, the TRAPPIT™ dome trap by Agrisense, LIQUIDATOR™ Trap by Phero Tech Inc., Yellow Jacket Wasp Trap™ by Oak Stump Farm (U.S. Pat. No. 4,794,724), the PHEROCON™ trap by Zoecon, Inc., the Universal moth trap or UNITRAP®, and the zea pheromone dispenser and trap from Hercon.

An example of a trap for the combination of the pheromone and enhancer is one that has a mixing chamber wherein vapors of the enhancer and pheromone form a blend and the vapor blend exits the trap chamber and attracts moths to the chamber where they are trapped. Compounds that produce the attractant vapor blend may be presented as a mixture or in separate dispensers within the trap. A drowning solution may be used in a trap, and the attractant blend can be formulated to emanate from the drowning solution. The drowning solution may optionally contain additional materials that aid in the capture and killing of attracted moths, such as detergents or wetting agents, clays, dyes and toxicant, as long as such additives do not substantially interfere with the attractiveness of the attractant blend of the invention. For dry traps, in which attracted moths are killed by toxicant or insolation, other formulation methods may be used as known in the art.

Thus, the attractant-compositions of the invention may be used in traps, such as those commonly used to attract noctuid moths such as cotton bollworm, beet army worm, corn earworm or tobacco bud worm. Such traps are well known to one skilled in the art, and are commonly used in many states and countries in their moth eradication programs. In one embodiment, the trap includes one or more septa, containers or storage receptacles for holding the attractant-composition. In some embodiments, the pheromone traps containing the attractant-composition may be combined with other kinds of trapping mechanisms. For example, in addition to the attractant-composition, the pheromone trap may include one or more florescent lights, one or more sticky substrates and/or one or more colored surfaces for attracting noctuid moths. In other embodiments, the pheromone trap containing the attractant-composition may not have other kinds of trapping mechanisms. In particular embodiments, the trap is a Tedders trap (See e.g., Stansly et al., Proc. Fla. State Hort. Soc. 110: 22-26 (1997)) or a Florida trap (See e.g., Mizell and Tedders, Proc. Southeast Pecan Growers Assoc. 90: 52-53) as known to one skilled in art.

Thus, the invention provides a method for attracting and trapping noctuid moths. The method includes administering to a predetermined site an effective amount of the attractant-composition. Such administering may be performed by adding the attractant-composition to a septa or storage receptacle of a trap described herein. A trap or plurality of traps containing the attractant-composition may be placed in a crop field. The trap(s) may be set at any time of the year in a field. The locations of the traps, and the height of the traps from ground may be selected in accordance with methods known to one skilled in the art. Those of skill in the art can readily determine an appropriate amount of the compositions to use in a particular trap, and can also determine an appropriate density of traps/acre of crop field to be protected. Examples of crop plants include, but are not limited to, cotton, corn, soybean, and various vegetable crops.

The method may include periodically monitoring the total number or quantity of the trapped insects. The monitoring may be performed by counting the number of insects trapped for a predetermined period of time such as, for example, daily, weekly, bi-weekly, monthly, once-in-three months, or any other time periods selected by the monitor. Such monitoring of the trapped insects may help estimate the population of insects for that particular period, and thereby help determine a particular type and/or dosage of pest control in an integrated pest management system. For example, when the number of trapped noctuid moths is more than a pre-determined level in a particular week, a chemical pesticide may be sprayed or applied to a crop field in order to control noctuid moths or a higher concentration of traps/acre may be set in a crop field in order to control noctuid moths during that particular week.

In some embodiments, the method includes adding a pesticide to the trap so as to kill the trapped noctuid moths. The pesticide may be a pesticide known to one skilled in the art. The pesticide may be mixed with the attractant-composition or may be separately present in a trap. Mixtures may perform the dual function of attracting and killing the noctuid moths.

The invention is also directed to kits. In one aspect the kit includes a trap and a lure for use within the trap and which provides the attractant. The kit may also include a drowning solution for some trap designs. Another kit includes at least two compounds, wherein one compound is a noctuid moth pheromone and another compound is trans-2, cis-6-nonadienal. The ingredients may be in a drowning solution, formulation (chemical matrix to hold and release one or more attractant chemicals), dispenser or bait as discussed above. Drowning solutions, formulations, dispensers and controlled release devices may be rechargeable with a measured amount of the attractant ingredients.

A bait kit may contain the compounds to provide the attractant component, combination or blend of the invention in a matrix or suitable carrier for moths to contact and remove. The bait may also contain additives, such as feeding stimulants, toxicants, extenders, antioxidants, and/or UV adsorbers.

The invention is also directed to a packaged attractant which comprises at least two ingredients as described above, wherein the at least two ingredients are packaged in separate containers and wherein the packaged attractant further comprises instructions for producing a volatilized blend.

The following examples are provided to further illustrate the invention described herein.

### EXAMPLES

### Example 1

### Heliothis Virescens Response to a Pheromone Synergist

An experiment was carried out near Monticello, Drew County in Arkansas to study the response of tobacco bud worm, Heliothis virescens to a pheromone synergist. The experiment was carried out in a habitat of cotton and soybean. β-caryophyllene was used as a synergist with a mixture of pheromones (Z,E)-9,12-tetradecadien-1-ol acetate and (Z)-9-tetradecen-1-ol acetate at the ratio of 7:3. Tedders traps were used in the experiment. Each pheromone trap was baited with the pheromone mixture and approximately 3-6 mg of β-caryophyllene and each control trap was baited with the pheromone mixture. The control trap contained no β-caryophyllene or other synergists. The pheromone mixture used in the experiment was LURETAPE®. obtained from Hercon Environmental in Emigsville, Pa. The trapped adult insects of Heliothis virescens were collected on a daily basis and the total number of trapped insects was counted. Statistical analysis was done using the Least Squares means separation from the SAS GLM procedure.

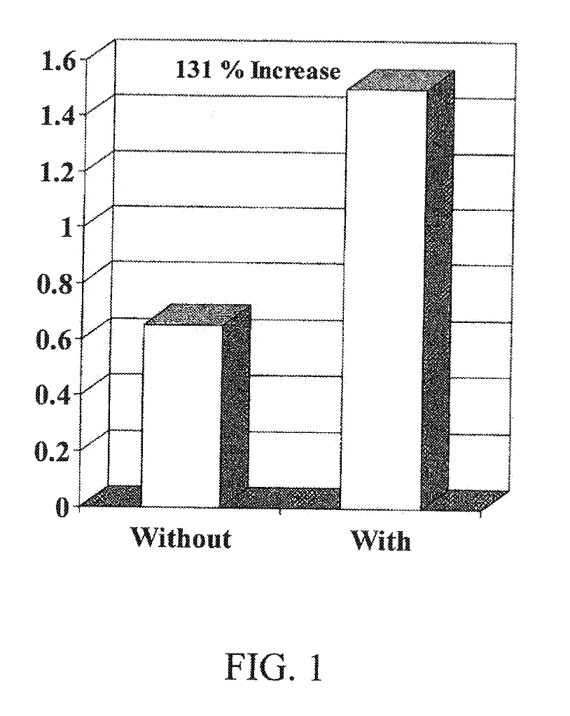

FIG. 1 illustrates the average number of moths trapped per day in year 2005. As illustrated in FIG. 1, there was about a 131% increase in the number of captured Heliothis virescens when β-caryophyllene was used as a synergist. The observed increase in captured moths was statistically significant at Pr>t 0.01 (1.106 df).

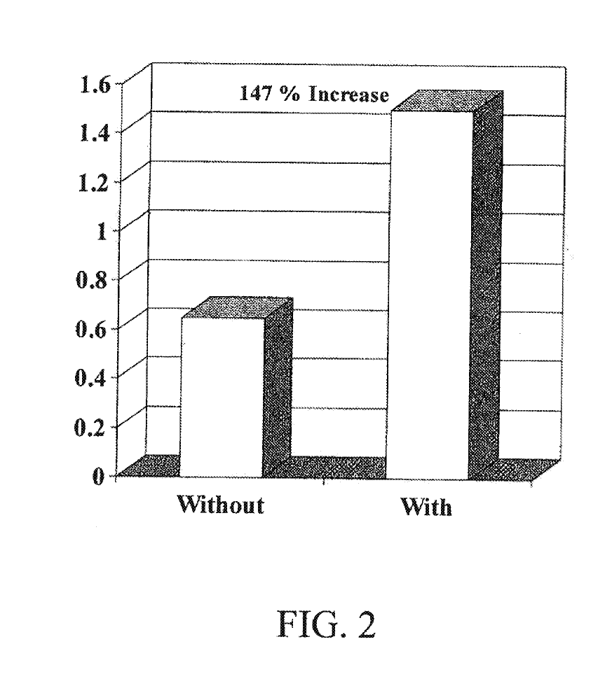

FIG. 2 illustrates the average number of moths trapped per day in year 2004. As illustrated in FIG. 2, there was about a 147% increase in the number of captured Heliothis virescens when β-caryophyllene was used as a synergist. The observed increase in captured moths was statistically significant at Pr>t 0.23 (2.48 df).

Accordingly, a mixture of pheromones (Z,E)-9,12-tetradecadien-1-ol acetate and (Z)-9-tetradecen-1-ol acetate, when used with β-caryophyllene, significantly improved the trap captures. Thus, β-caryophyllene acts as a synergist with the mixture to attract Heliothis virescens.

### Example 2

### Spodoptera Exigua Response to a Pheromone Synergist

An experiment was carried out in three locations in Arkansas to study the response of beet army worm, Spodoptera exigua, in a cotton field to a pheromone synergist. The locations were near Fayetteville, Washington County, near Tillar, Drew County, and near Foreman. Little River County. β-caryophyllene was used as a synergist with (Z)-11-hexadecen-1-ol, a pheromone for Spodoptera exigua. Tedders traps were used in the experiment. Each pheromone trap was baited with (Z)-11-hexadecen-1-ol and approximately 3-6 mg of β-caryophyllene and each control trap was baited with (Z)-11-hexadecen-1-ol. The control trap contained no 13-caryophyllene or other synergists. The trapped adult insects of Spodoptera exigua were collected on a daily basis and the total number of trapped insects was counted. Statistical analysis was done using the Least Squares means separation from the SAS GLM procedure.

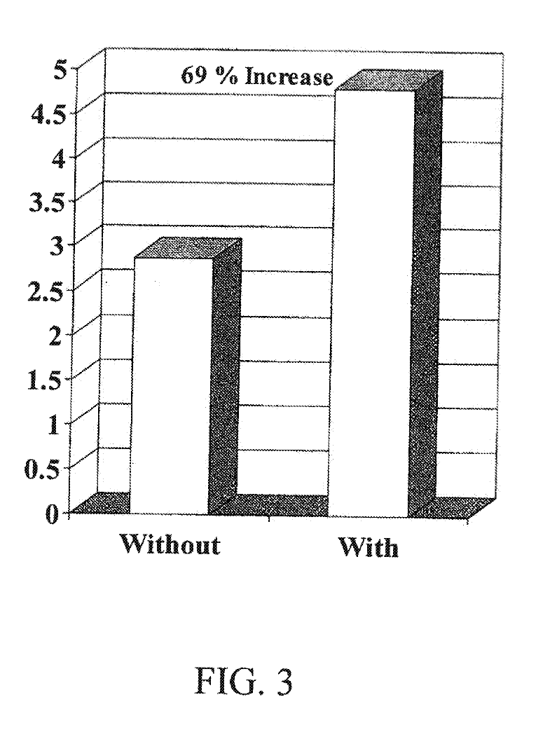

FIG. 3 illustrates the average number of moths trapped per day in year 2005. As illustrated in FIG. 3, there was about a 69% increase in the number of captured Spodoptera exigua when β-caryophyllene was used as a synergist. The observed increase in captured moths was statistically significant at Pr>t 0.01 (1.63 df).

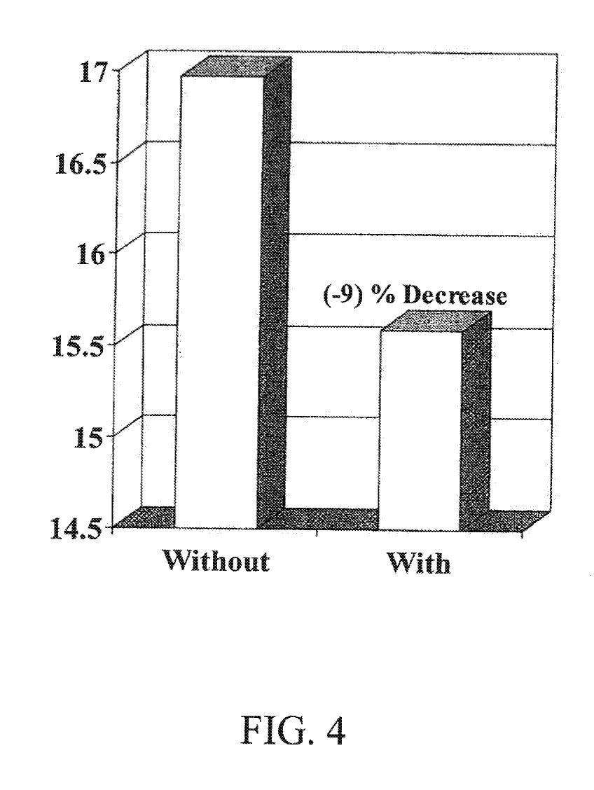

FIG. 4 illustrates the average number of moths trapped per day in year 2004. As illustrated in FIG. 4, there was about a −9% decrease in the number of captured Spodoptera exigua when β-caryophyllene was used as a synergist. This decrease may possibly be due to unknown interacting environmental factors in year 2004.

As per year 2005 data illustrated in FIG. 3, the pheromone, (Z)-11-hexadecen-1-ol, when used with β-caryophyllene, significantly improved the trap captures. Thus, in certain conditions, (Z)-11-hexadecen-1-ol acts synergistically with β-caryophyllene to attract Spodoptera exigua.

### Example 3

### Heliothis zea Response to a Pheromone Enhancer

Heliothis zea Test 1

12 traps were set in Yazoo City and 10 in Monroe County, Miss. From mid June through mid September trans-2, cis-6-nonadienal, a compound reported from the volatiles of corn and soybean plants was tested. Both treatments used a commercial Heliothis zea pheromone dispenser produced by Hercon. The standard was this lure only, while the enhanced traps also contained a dispenser produced in-house that contained the enhancer. Table 1 below shows counts from different evaluations in Yazoo County.

TABLE 1

| | | Standard + 14 mg | |
|---|---|---|---|
| Evaluation | Standard | trans-2, cis-6-nonadienal | |
| 1 | 121 | 102 | |
| 2 | 46 | 122 | |
| 3 | 2 | 7 | |
| 4 | 162 | 291 | |
| 5 | 52 | 30 | |
| 6 | 87 | 128 | |
| 7 | 0 | 2 | |
| 8 | 20 | 33 | |
| 9 | 24 | 28 | |
| 10 | 182 | 257 | |
| Total moths captured | 696 | 1000 | (44% increase) |

Heliothis zea, Test 2

The percent increase in Heliothis zea captures with the addition of the soybean volatile trans-2,cis-6-nonadienal was 44%, 25%, and 54% respectively for Mississippi and Arkansas in test 1 and in Arkansas in test 2.

What is claimed is:

1. A composition comprising:
a) at least one pheromone compound that attracts at least one species of Heliothis; and
b) trans-2, cis-6-nonadienal.

2. The composition according to claim 1, wherein said pheromone is selected from the group consisting of Z-11-hexadecenal (Z-11-16:A1d), Z-9-hexadecenal (Z-9-16:A1d), Z-7-hexadecenal (Z-7-16:A1d), hexadecenal, and combinations of any two, three or four of Z-11-hexadecenal (Z-11-16:A1d), Z-9-hexadecenal (Z-9-16:A1d), Z-7-hexadecenal (Z-7-16:A1d), or hexadecenal.

3. The composition according to claim 1, wherein said species of Heliothis is Heliothis zea.

4. The composition according to claim 1, wherein the composition comprises from 0.5 to 50 mg of trans-2, cis-6-nonadienal.

5. The composition according to claim 1, wherein the composition comprises from 1 to 25 mg of trans-2, cis-6-nonadienal.

6. A trap for capturing an insect comprising:
a) at least one pheromone compound that attracts at least one species of Heliothis; and
b) trans-2, cis-6-nonadienal.

7. The trap according to claim 6, wherein said pheromone is selected from the group consisting of Z-11-hexadecenal (Z-11-16:A1d), Z-9-hexadecenal (Z-9-16:A1d), Z-7-hexadecenal (Z-7-16:A1d), hexadecenal, and combinations of any two, three or four of Z-11-hexadecenal (Z-11-16:A1d), Z-9-hexadecenal (Z-9-16:A1d), Z-7-hexadecenal (Z-7-16:A1d), or hexadecenal.

8. The trap according to claim 6, wherein said species of Heliothis is Heliothis zea.

9. The trap according to claim 6, comprising from 0.5 to 50 mg of trans-2, cis-6-nonadienal.

10. The trap according to claim 6, comprising from 1 to 25 mg of trans-2, cis-6-nonadienal.

11. The trap of claim 6, wherein said pheromone and said trans-2, cis-6-nonadienal are mixed.

12. The trap of claim 6, wherein said pheromone and said trans-2, cis-6-nonadienal are at discrete sites in said trap.

13. The trap of claim 12, wherein said pheromone and said trans-2, cis-6-nonadienal are in sufficient proximity effective to provide an effective noctuid moth attractant amount of a vapor blend of said pheromone and said trans-2, cis-6-nonadienal.

14. The trap of claim 12, further comprising an insect growth regulator.

15. A method of preparing a trap for attracting noctuid moths comprising:
administering to a substrate an effective amount of a first and second agent for attracting at least one species of a noctuid moth, wherein said first agent is a pheromone compound that attracts at least one species of Heliothis and said second agent is trans-2, cis-6-nonadienal.

16. The method of claim 15, wherein said substrate is in a trap.

17. The method of claim 15, wherein said substrate comprises from 0.5 to 50 mg of trans-2, cis-6-nonadienal.

18. The method of claim 15, further comprising administering a third agent, wherein said third agent is an insect growth regulator.

19. The method of claim 18, wherein said insect growth regulator is an insect sterilant.

20. The method of claim 15, wherein said Heliothis is Heliothis zea.

21. A method for attracting noctuid moths comprising placing in a field a trap comprising an effective amount of a first and second agent for attracting at least one species of a noctuid moth, wherein said first agent is a pheromone compound that attracts at least one species of Heliothis and said second agent is trans-2, cis-6-nonadienal, whereby said noctuid moths are attracted to said trap.

22. The method of claim 21, wherein more noctuid moths are attracted to said trap than a trap lacking said second agent.

23. The method according to claim 22, wherein said noctuid moths are increased by at least 10% as compared to said trap lacking said second agent.
